(19) United States
(12) Patent Application Publication
(10) Pub. No.: US 2012/0111804 A1
(43) Pub. Date: May 10, 2012

(54) APPARATUS AND METHOD FOR PURIFYING THERMOPLASTIC POLYMERS

(75) Inventors: Thomas Friedlaender, Regensburg (DE); Klaus-Karl Wasmuht, Ellingen (DE); Jörg Zacharias, Kofering (DE); Stephan Mayr, Regensburg (DE)

(73) Assignee: KRONES AG, Neutraubling (DE)

(21) Appl. No.: 13/281,703

(22) Filed: Oct. 26, 2011

(30) Foreign Application Priority Data
Oct. 26, 2010 (DE) 102010042967.8

(51) Int. Cl. B01D 35/18; B01D 37/04; B01D 35/02

(52) U.S. Cl. 210/774; 210/181; 210/137; 210/149; 210/103

(57) ABSTRACT

An apparatus for purifying thermoplastic polymers, including a means for generating and conveying a polymer melt, the means including a first heating unit and a filter means, and the filter means including a second heating unit. And a method for purifying thermoplastic polymers, including a step of filtering a polymer melt by way of a filter means, wherein the filter means is at least temporarily heated to a temperature which is higher than that of the polymer melt.

### CROSS-REFERENCE TO RELATED APPLICATION

The present application claims the benefit of priority of German Application No. 102010042967.8, filed Oct. 26, 2010. The entire text of the priority application is incorporated herein by reference in its entirety.

### FIELD OF THE DISCLOSURE

This disclosure relates to an apparatus and a method for purifying thermoplastic polymers and in particular to the purification of to-be-recycled packaging materials made of thermoplastic polymers.

### BACKGROUND

Against the background of the scarcity of fossil raw materials, packaging materials, most of which are made of polymers based on petrol, are increasingly being recycled nowadays. Examples of thermoplastic polymers are, among others, polyester, polyolefins, polystyrenes, polyamides or polycarbonates, in particular PET, or copolymers thereof. During the recycling process, the packaging materials are generally collected after having been used, sorted according to the type of material by means of mechanical and physical separating methods, then cut into smaller pieces, the so-called polymer flakes, and washed. These polymer flakes represent an intermediate product, and they are subsequently reconverted by a continuous extrusion and granulation process into polymer pellets which then can be transformed again into any desired products such as packaging materials.

The generated polymer flakes are, however, generally contaminated, i.e. they contain foreign matter which is usually separated during the extrusion and granulation process in order to improve the quality of the resulting polymer pellets so that the same can be used as a raw material for various high-quality products.

Foreign matter is to be understood as including particularly impurities constituted by particles in the size range of several mm to μm that could not be separated by the preceding mechanical and physical purification processes. In the case of flakes of PET bottles, these particles include primarily solid matter such as sand, stones, glass, metals, wood, rubber, ceramics, etc.

Traditionally, these particles are mechanically filtered out of the polymer melt in the extrusion process by passing the melt across a filter positioned inside the extrusion apparatus and capable of retaining the particles.

In this process, the problem arises that the filter becomes clogged/blocked with the ongoing operation of the extrusion apparatus, leading to a reduced flow rate of the polymer melt. This causes a pressure build-up upstream of the filter and a pressure loss downstream thereof, which results in back pressures of up to 150 bar. This, in turn, means that the filter is no longer operable and that a back washing, cleaning or replacement of the filter is required. One of the causes for the clogging or blocking of the filter lies in the inhomogeneous consistency of the polymer melt which can contain constituent parts having a relatively high melting point so that the temperature of the polymer melt is so low that these constituent parts will deposit on the filter means as a solid polymer mass.

From prior art, it is known to obtain a purifying effect by increasing the temperature of the extrusion apparatus, thus returning polymer constituent parts deposited on the filter into the melt. Furthermore, a melt has a lower viscosity at higher temperatures and can be better filtered. This, however, implies the disadvantage that simultaneously the temperature of the polymer melt across the whole extruder area also increases, leading to undesirable degradation reactions in temperature-sensitive polymers such as PET and thus deteriorates the quality of the resulting polymer pellets.

The apparatuses and methods disclosed in prior art generally have the drawback that the filter for separating foreign matter from the polymer melt rapidly becomes blocked or clogged so that it must be frequently replaced. Furthermore, the systems known from prior art do not allow cleaning of the filters during an ongoing operation without impairing the quality of the resulting polymer product, i.e. in the methods according to prior art, particularly in the case of inhomogeneous polymer reactants, maintenance is frequently required.

DE 199 12 433 A1 shows a filter apparatus for filtering molten plastics, said apparatus comprising a heat exchanger. DE 11 51 927 B discloses a screw-type injection machine having a sieve at the discharge point, the sieve being heatable. EP 0 960 716 A1 shows an apparatus for filtering thermoplastic melt for extruders. WO 2008/153691 A1 discloses an extrusion system using a pressure sensor.

JP 5 069 470 A and JP 11 156 920 A show methods for producing an extruded film, said methods using a filter.

### SUMMARY OF THE DISCLOSURE

Hence, some aspects of the disclosure are to provide an apparatus and a method for purifying thermoplastic polymers wherein foreign matter can be effectively separated without requiring much maintenance, and wherein the quality of the resulting polymer product is not lowered, even with inhomogeneous polymer reactants.

These aspects are achieved with a generic apparatus according to the disclosure in that the filter means comprises a second heating unit.

By providing a second, separate heating unit, it is possible to heat the filter means directly and in a targeted manner to a temperature that is higher than that of the polymer melt, whereby a deposition of polymer material on the filter means and a blocking of the filter means is effectively prevented. Furthermore, the second, separate heating unit allows to rapidly heat the filter means so that polymer material already deposited can be rapidly and effectively returned into the melt, thus bringing about the unblocking of the filter means. Due to this fact, the maintenance of the apparatus according to the disclosure is very low as compared to conventional apparatuses.

Due to the configuration according to the disclosure, the temperature rise takes place only in a locally limited manner in the area of the filter means so that the total energy input into the polymer melt which is necessary for unblocking the filter means can be minimized. Thereby, an overheating of the polymer melt can be avoided and, consequently, a decomposition of the polymer chains can be prevented or can be significantly reduced. Consequently, a high quality of the resulting polymer product can be guaranteed.

This is of particular importance in the case of polyethylene terephtalate since a temperature rise of the PET melt for a longer time period up to 300° C. to 350° C., which is necessary for unblocking the filter means, leads to undesirable degradation reactions such as a reduction of the chain length which, in turn, entrains an undesirable reduction of the intrinsic viscosity and the generation of acetaldehyde (AA), thus lowering the quality of the resulting polymer recyclate.

The filter means preferably comprises one or more of a particle filter whose mesh width lies in the range of 100 μm to 1000 μm, preferably in the range of 200 μm to 500 μm. Due to such a configuration, foreign matter present in the polymer can be efficiently filtered out.

Alternatively to or in combination with these particle filters, the filter means according to the disclosure comprises one or more of a micro-sieve, the mesh width of which is smaller than that of the particle filters and lies preferably in the range of 10 μm to 100 μm, particularly preferred in the range of 20 μm to 50 μm. Due to the presence of such a micro-sieve, even small-sized impurities can be filtered out from the polymer melt.

In a preferred embodiment of the apparatus, a plurality of particle filters and/or micro-sieves are included, preferably 4 or more, particularly preferred 8 or more. They are arranged such that the size of the mesh width of the individual filters, with regard to the flow direction of the polymer melt, decreases successively. Due to the presence of such an arrangement, a particularly effective filtering effect can be achieved wherein, due to fact that the separation of foreign particles is graduated according to their size by the use of different filters or micro-sieves, respectively, the time period until the filter means becomes clogged by the particles to be filtered can be further extended to a maximum.

Preferably, each of the particle filters and/or each of the micro-sieves includes a separate heating unit. This enables a particularly effective cleaning process of the individual particle filters and/or micro-sieves present in the filter means by a targeted increase in temperature of only single ones of the particle filters and/or micro-sieves.

In another preferred embodiment, the means for generating and conveying the polymer melt comprises at least one sensor for determining the melt pressure and/or the temperature of the polymer melt. This sensor can be arranged upstream or/and downstream of the filter means, with regard to the flow direction of the polymer melt. In addition, in this embodiment the apparatus preferably comprises a control unit which, by using the data determined by the sensor, controls the second heating unit. This enables the second heating unit to be operated with particular efficiency so that the required temperature input for cleaning the filter means can be further minimized, thus contributing to an additional improvement of the quality of the polymer product. Furthermore, it is thereby possible to put the temperature of the polymer melt exiting the filter into relation to the melting point of the polymer so as not to impair the subsequent cooling and crystallization processes.

The above-described further aspects are achieved according to the disclosure in that the filter means is at least partially heated to a temperature which is higher than that of the polymer melt itself. Due to such a method, it is possible to filter foreign matter effectively and with low maintenance from polymer melts, simultaneously ensuring a high quality of the polymer product even if the polymer reactant is inhomogeneous.

In a preferred embodiment of the disclosure, the difference between the temperature of the polymer melt and the temperature of the filter means lies in the range of 110° C. to 40° C., preferably of 90° C. to 50° C. Due to such a setting of the temperature difference, an effective cleaning of the filter means can be carried out without impairing the quality of the resulting polymer product, since the additional energy input into the polymer melt is very small.

Furthermore, the temperature of the polymer melt lies preferably in the range of 250° C. to 300° C., more preferably in the range of 270° C. to 290° C., and the filter means is heated to a temperature in the range of 300° C. to 360° C., more preferably in the range of 320° C. to 350° C. These temperatures are particularly preferable when recycling PET flakes since otherwise a not to be neglected risk of deterioration of PET results, causing a decrease of the intrinsic viscosity of the resulting PET recyclate and an elevated value of acetaldehyde.

In a further preferred configuration, the melt pressure of the polymer melt before the filtering step is less than 150 bar, preferably less than 125 bar, most preferably less than 100 bar. Thereby, it can be guaranteed that the durability of the filter means as well as the throughput rate of the polymer melt lie in an acceptable range, ensuring a particularly effective and low-maintenance operational procedure.

According to the disclosure, the filter means is heated via the second, separate heating unit to a temperature that is higher than that of the polymer melt. Due to this second heating unit, the thermal load on the polymer melt is, however, low enough so as not to cause any significant deterioration of the quality of the polymer melt.

Alternatively, it is also possible to carry out the heating process of the filter means to a temperature higher than that of the polymer melt only over a limited time period, preferably in intervals. It is particularly preferable to keep the time period for heating the filter means to a temperature that is higher than that of the polymer melt at less than 30 min, more preferably at less than 10 min, most preferably at less than 2 min. Furthermore, it is convenient that the heating intervals will last more than 1 hour, preferably more than 5 hours, most preferably more than 10 hours. Due to such a discontinuous procedural arrangement, the temperature input into the polymer melt required for cleaning the filter means can be further minimized, thus obtaining a particularly good quality of the resulting polymer product.

Preferably, the method further comprises a step of controlling the temperature and/or the heating time and/or the heating interval of the filter means, the control parameter being at least one selected from the group consisting of the temperature of the polymer melt before the filtering step, the temperature of the polymer melt after the filtering step, the melt pressure of the polymer melt before the filtering step, and the melt pressure of the polymer melt after the filtering step. Due to this control step, in particular the temperature at the exit of the filter means can be controlled in a determined relation to the melting point of the polymer such as not to impair the subsequent cooling and crystallization processes. Furthermore, an increasing pressure can be observed, caused by an increasing clogging of the filter means at the non-filtered side, i.e. at the side up-stream of the filter means. By measuring the melt pressure upstream and/or downstream of the filter means and by using this measurement value as a control parameter for the temperature setting of the filter means via the second heating element, a temperature above the danger zone (i.e. a temperature at which inhomogeneities occur) can be set in a targeted manner. This control is only limited by the admissible maximum temperature which the melt is allowed to reach, said maximum temperature being preferably determined via a parallel temperature measurement.

Alternatively to or additionally to the measurement/control via the control parameters mentioned above, it is particularly preferable to control the temperature of the filter means during the process, the control parameter being at least one selected from the group consisting of the melting temperature and/or the glass transition temperature of the polymer reactant, the intrinsic viscosity of the polymer reactant, the melting temperature and/or the glass transition temperature of the polymer product, and the intrinsic viscosity of the polymer product. Through such a control by means of these control parameters, an additional fine adjustment of the method according to the disclosure is possible so as to further optimize the method with regard to the quality of the polymer melt.

### BRIEF DESCRIPTION OF THE DRAWINGS

The present disclosure and its advantages will be explained in more detail on the basis of the appended drawings. In the figures show:

FIG. 1 a schematic sectional view of an apparatus according to the disclosure,

FIG. 2 an enlarged sectional view of a preferred embodiment of the filter means,

FIG. 3 a preferred embodiment of a particle filter or micro-sieve, respectively,

FIG. 4 a further preferred embodiment of a particle filter or micro-sieve, respectively,

FIG. 5 a schematic view of a preferred embodiment of the apparatus including a control device.

### DETAILED DESCRIPTION OF THE PREFERRED EMBODIMENT

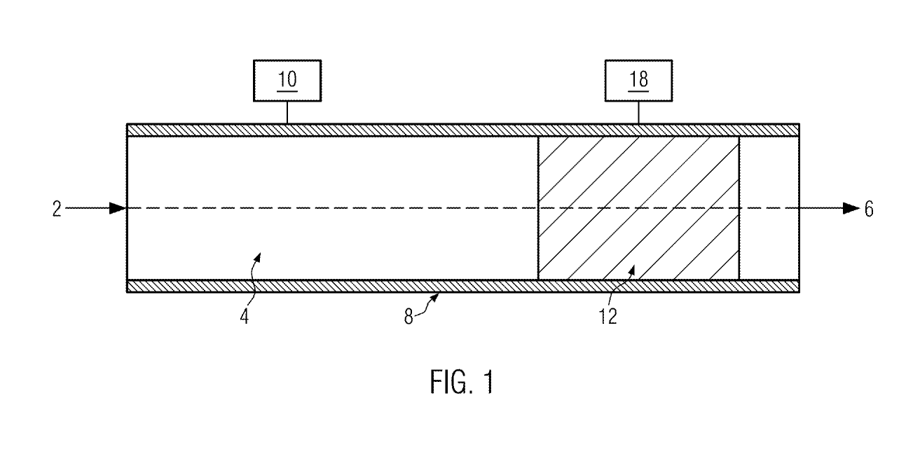

FIG. 1 schematically shows an apparatus for purifying thermoplastic polymers, comprising a means 8 for generating and conveying a polymer melt 4, the polymer melt 4 being contained therein. The means 8 includes a first heating unit 10 for heating the polymer melt 4 flowing through in the direction of arrow 2. Furthermore, within the means 8 a filter means 12 is contained comprising, according to the disclosure, a second, separate heating unit 18 by means of which the temperature of the filter can be set independently from the temperature of the polymer melt.

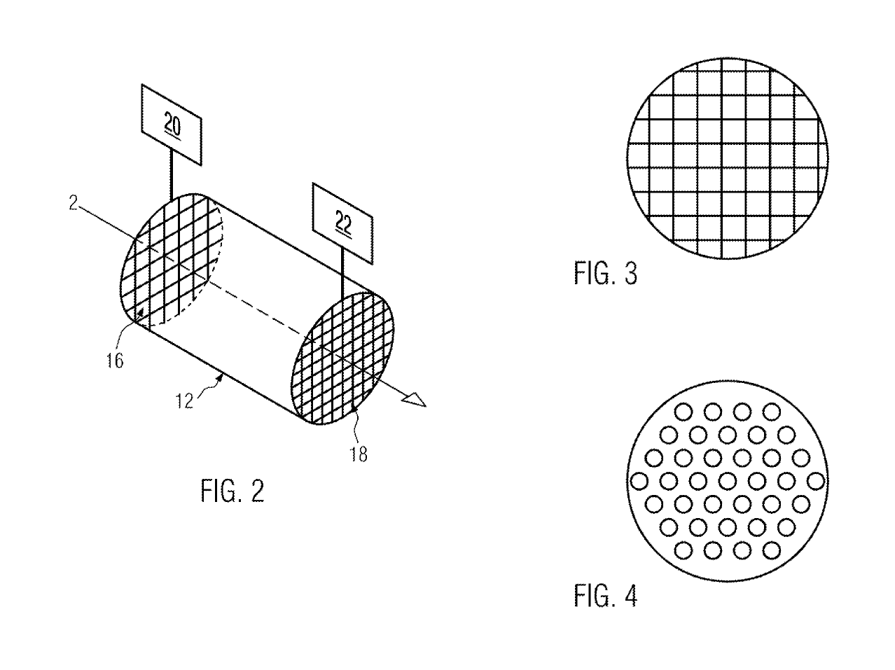

FIG. 2 shows a preferred embodiment of filter means 12. In this configuration, the filter means comprises a particle filter 16 and a micro-sieve 18 in an arrangement in which the polymer melt first passes the particle filter 16 and then the micro-sieve 18. Furthermore, the particle filter 16 and the micro-sieve 18 each have a separate heating unit 20 and 22, respectively, serving to set the temperatures of the particle filter 16 and of the micro-sieve 18 separately. The configuration of the particle filters and of the micro-sieves can be freely selected, particularly preferred are grid filters and perforated stainless steel plates according to FIGS. 3 and 4.

The position of filter means 12 in the means for generating and conveying the polymer melt 4 can be freely selected, but a position on the rear end, as referred to the discharge direction of the polymer melt, is preferable so that a sufficient heating to the desired temperature of the polymer melt is guaranteed. A tubular configuration of the means 8 for generating and conveying the polymer melt 4 is particularly preferable, for example in the form of a single screw extruder or double screw extruder.

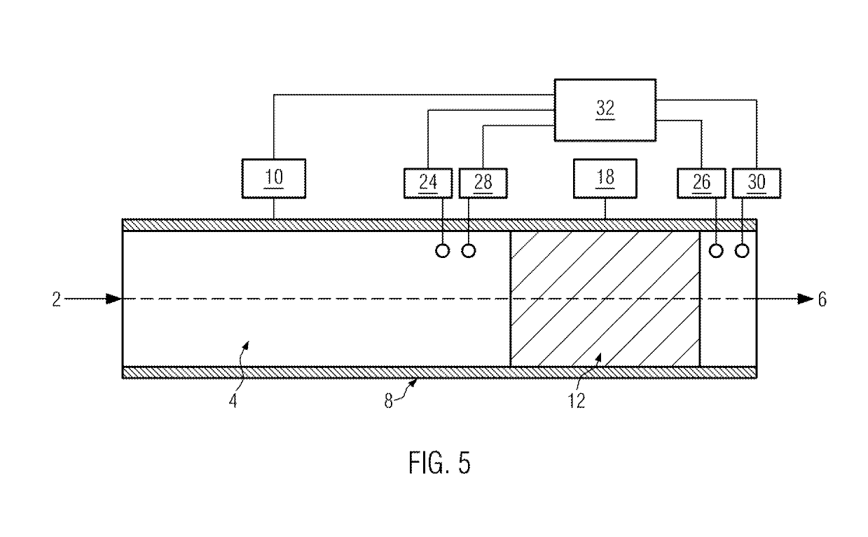

FIG. 5 shows a preferred embodiment of the apparatus comprising a sensor 24 for determining the melt pressure upstream of the filter means 12, a sensor 26 for determining the melt pressure downstream of the filter means 12, a sensor 28 for determining the temperature of the polymer melt 4 upstream of the filter means 12, and a sensor 30 for determining the temperature of the polymer melt 4 downstream of the filter means 12. The terms “upstream/downstream” refer to the flow direction of the polymer melt 4, i.e. from the input point of the polymer reactant 2 in the direction of the discharge point of the polymer product 6. The sensors, 24, 26, 28 and 30 are connected to a control unit 32 controlling the temperature of the second heating unit 18. Additionally, a control of the first heating unit 10 is possible.

By means of the apparatus according to FIG. 1, the method according to the disclosure can be carried out as follows:

The polymer reactant, for example in the form of polymer flakes, is introduced in the direction of arrow 2 into the means 8 for generating and conveying the polymer melt 4, and is conveyed to the point of discharge of the polymer product 6. By means of the first heating unit 10, the temperature of the introduced polymer reactant is raised, causing the formation of the polymer melt 4. The latter is then filtered by means of the filter means 12 to separate foreign particles therefrom. The filter means 12 is heated, at least temporarily, to a temperature that is higher than that of the polymer melt 4. The temperature of the filter means 12 can be higher than that of the polymer melt 4 during the whole duration of the process. Alternatively, it is also possible to heat the filter means 12 to a temperature which is higher than that of the polymer melt 4 only for a limited time period, and preferably in time intervals.

By heating the filter means 12, the deposition of constituent parts of the polymer melt 4 in the filter means 12 is prevented, and polymer constituent parts already deposited thereon are again returned into the melt. Due to the direct and targeted additional temperature input directly at the location of the filter means 12, the undesirable temperature rise of the polymer melt 4 can be reduced such that no undesirable degradation of the polymer product 6 occurs, and thus a high quality of the product can be ensured.

According to FIG. 2, in a preferred embodiment of the method, the filter means 12 comprises a particle filter 16 and a separate micro-sieve 18 which, with regard to the flow direction of the polymer melt 4, is arranged downstream. The particle filter 16 and the micro-sieve 18 each have a separate heating unit 20 and 22, respectively, by means of which the temperatures of the particle filter 16 and that of the micro-sieve 18 can be set independently from each other and can be identical or different from each other. In a preferred configuration, the temperature of the micro-sieve 18 is higher than that of the particle filter 16 since, due to the fact that the mesh width of the micro-sieve 18 is smaller, the risk that the sieve becomes blocked is higher than in the particle filter 16 which has a larger mesh width. Due to this preferred arrangement, the required energy input for cleaning the filter means 12 can be further minimized, and thus the quality of the polymer product 6 can be additionally improved.

In a particularly preferable operational procedure, the heating of the filter means 12 to a temperature which is higher than that of the polymer melt 4 is performed only for a limited time period, i.e. not continuously. For the time during which the temperature of the filter means 12 is not higher than that of the polymer melt 4, the temperature of the filter means 12 is preferably set to the temperature of the polymer melt 4 so as to avoid cooling of the polymer melt 4 by the filter means 12. By heating the filter means 12 only over a limited time period to a higher temperature than that of the polymer melt 4, the required temperature input, i.e. the thermal load on the polymer material, can be further reduced. Furthermore, the heating of the filter means 12 is preferably carried out in intervals so that, if there is a risk of blocking the filter means 12 by high-molecular constituent parts of the polymer melt, such constituent parts can be eliminated in due time. The duration of heating the filter means 12 and the time intervals are selectable according to the framework conditions as defined above.

In particular, according to a particularly preferable embodiment of the method, as represented in FIG. 5, a step of controlling the temperature and/or the heating time and/or the heating interval of the filter means 12 is provided. In this step, one or a plurality of control parameters, such as the temperature of the polymer melt 4 before the filtering step, the temperature of the polymer melt 4 after the filtering step, the melt pressure of the polymer melt 4 before the filtering step, and the melt pressure of the polymer melt 4 after the filtering step are measured via the sensors 24, 26, 28, and 30. These measurement values represent the control parameters which are processed in the control unit 32, so that the temperature of the filter means 12 can be controlled via the second heating unit 18. Alternatively or additionally, the temperature of the polymer melt 4 can also be controlled via the first heating unit 10. Due to such a control mechanism, a particularly effective operational procedure is possible since the temperature of the filter unit 12 can be set directly, rapidly and in a target-oriented manner.

1. An apparatus for purifying thermoplastic polymers, comprising a means for generating and conveying a polymer melt, the means comprising a first heating unit and a filter means, the filter means comprising a second heating unit.

2. The apparatus according to claim 1, wherein the filter means comprises one or more of a particle filter the mesh widths of which lie in the range of 100 μm to 1000 μm.

3. The apparatus according to claim 2, wherein the filter means comprises one or more of a micro-sieve the mesh widths of which lie in the range of 10 μm to 100 μm.

4. The apparatus according to claim 3, wherein one of the particle filter, the micro-sieve, and a combination thereof are arranged such that the size of the mesh width of the individual filters, with regard to the flow direction of the polymer melt, decreases successively.

5. The apparatus according to claim 4, wherein each of the particle filter, the micro-sieve, and a combination thereof comprises a separate heating unit.

6. The apparatus according to claim 1, wherein the means for generating and conveying the polymer melt comprises at least one sensor for determining one of the melt pressure, the temperature of the polymer melt and a combination thereof, the sensor being arranged one of upstream, downstream, and a combination thereof of the filter means with regard to the flow direction of the polymer melt, and a control unit.

7. The method for purifying thermoplastic polymers, comprising filtering a polymer melt by way of a filter means, wherein the filter means is heated at least temporarily to a temperature, which is higher than that of the polymer melt.

8. The method according to claim 7, wherein the difference of the temperature of the polymer melt with respect to the temperature of the filter means lies in the range of 110° C. to 40° C.

9. The method according to claim 7, wherein the temperature of the polymer melt lies in the range of 250° C. to 300° C., and the filter means is heated to a temperature in the range of 300° C. to 360° C.

10. The method according to claim 7, wherein the melt pressure of the polymer melt before the filtering step is less than 150 bar, preferably less than 125 bar.

11. The method according to claim 7, wherein the heating of the filter means to a temperature which is higher than that of the polymer melt is performed one of continuously and only over a limited time period.

12. The method according to claim 11, wherein the time period for heating the filter means to a temperature which is higher than that of the polymer melt is less than 30 min.

13. The method according to claim 23, wherein the heating intervals last more than 1 hour.

14. The method according to claim 7, and controlling one of the temperature, the heating time, the heating interval, and a combination thereof of the filter means, the control parameter being at least one selected from the group consisting of the temperature of the polymer melt before the filtering step, the temperature of the polymer melt after the filtering step, the melt pressure of the polymer melt before the filtering step, and the melt pressure of the polymer melt after the filtering step.

15. The method according to claim 7, and controlling the temperature of the filter means during the process, the control parameter being at least one selected from the group consisting of one of the melting temperature, the glass transition temperature, and a combination thereof of the polymer reactant, the intrinsic viscosity of the polymer reactant, one of the melting temperature, the glass transition temperature, and a combination thereof of the polymer product, and the intrinsic viscosity of the polymer product.

16. The apparatus according to claim 2, wherein the mesh widths lie in the range of 200 μm to 500 μm.

17. The apparatus according to claim 3, wherein the mesh widths lie in the range of 20 μm to 50 μm.

18. The method according to claim 8, wherein the temperature difference lines in the range of 90° C. to 50° C.

19. The method according to claim 9, wherein the temperature of the polymer lines in the range of 270° C. to 290° C.

20. The method according to claim 9, wherein the filter means is heated to a temperature of in the range of 320° C. to 350° C.

21. The method according to claim 10, wherein the melt pressure is less than 125 bar.

22. The method according to claim 10, wherein the melt pressure is less than 100 bar.

23. The method according to claim 11, wherein the heating when performed only over a limited time is in intervals.

24. The method according to claim 12, wherein the time period is less than 10 minutes.

25. The method according to claim 12, wherein the time period is less than 2 minutes.

26. The method according to claim 23, wherein the time intervals last more than 5 hours.

27. The method according to claim 23, wherein the time intervals last more than 10 hours.
